(19) United States
(12) Patent Application Publication
(10) Pub. No.: US 2026/0211989 A1
(43) Pub. Date: Jul. 23, 2026

(54) Method for identifying or authenticating a user of a virtual or mixed reality system

(71) Applicant: BANKS AND ACQUIRERS INTERNATIONAL HOLDING, SURESNES (FR)

(72) Inventor: Jerome MARCON, PARIS (FR)

(21) Appl. No.: 19/141,421

(22) PCT Filed: Dec. 14, 2023
(86) PCT No.: PCT/EP2023/085856

§ 371 Date: Jun. 20, 2025

(30) Foreign Application Priority Data
Dec. 21, 2022 (FR) FR2214116

(51) Int. Cl. G06F 21/32; G06F 3/01; G06F 21/36

(52) U.S. Cl. CPC G06F 21/32; G06F 21/36; G06F 3/011

(57) ABSTRACT

A method for identifying or authenticating a user of a virtual or mixed reality system, which includes an immersive space display and a movement detector for detecting the movement in the immersive space of a virtual plotting device. The method includes implementing, by a data processor of a first server connected to the system: obtaining from the system data representative of a candidate three-dimensional graphic object drawn by the user in the immersive space with the virtual plotting device; and biometrically classifying the data representative of a candidate three-dimensional graphic object drawn by the user in the immersive space with the virtual plotting device, by using a classification model trained on a learning base of data representative of reference three-dimensional graphic objects.

### GENERAL TECHNICAL FIELD

The present invention relates to the field of virtual or mixed reality. More specifically, it relates to a method for authenticating or identifying a user of a virtual or mixed reality system.

### STATE OF THE ART

Known are environments artificially generated by computers that can be perceived in virtual (or mixed, i.e. coexisting with the real world) reality and in particular the “metaverse” which would be a persistent, shared virtual world, and presented as the future of the internet.

To interact in such a universe, a user uses a virtual reality (VR), or where appropriate mixed reality (MR), headset.

This type of headset typically works by pairing with two controllers (or joysticks), held in each hand by the user. A controller is primarily used for interactivity: it acts as a pointing device, and also exposes various mechanical buttons, each assignable to a specific interactivity function, depending on the choice of the VR application.

This type of headset and the controllers are further equipped with motion sensors (typically accelerometers), dedicated to vision tracking, hand tracking and physical movement area management.

In some models, the user can alternatively do without the controllers, and use their hands free to interact with the application (for example, there are fixed external cameras that observe their hands).

In these environments, it is sometimes necessary to obtain a proof of consent from the user, and to do this to verify his identity, for example for transaction validation, and in particular for payment (if the user purchases an object, real or virtual, in the metaverse).

We can use conventional techniques like a PIN code or a password, for example via a paired smartphone, but we have to take the headset off and put it back on, which is cumbersome.

The biometric authentication factors (voice, iris, fingerprint) could expand these mechanisms in the more or less near future, but they require dedicated acquisition means (for example, a fingerprint scanner on the controller), and there is no known implementation. It is noted that the headsets have eye sensors, but they are limited to the simple function of eye tracking and they are far from having the performance that would allow iris recognition.

Alternatively, a natural way to obtain user consent in virtual space is to ask him to execute a particular gesture. This method is even more interesting if each user has a characteristic way of performing this gesture (a so-called “identifying” gesture).

But at first sight, all types of usable gestures have weaknesses:
eye gesture (blinking) or facial expression: non-identifying, can be triggered inadvertently, and sensor not yet mainstream.
static hand pose: non-identifying- and requires releasing the controllers
controller or hand gesture: still not very identifiable, not really recoverable at the application level, and difficult to perform regularly unless it is basic.

Another problem common to all these methods: the difficulty or impossibility of recording the gesture, for the purposes of non-repudiation.

It would be desirable to have a solution for authenticating a user in the VR space, having the following properties:
compatible with most VR headsets, connected or standalone, without the need for a specific VR sensor
not requiring the additional use of the user's smartphone
having sufficient user identification capacity (among N)
being easy to reproduce and memorize by the user
being difficult to imitate by another user
being difficult to generate and imitate programmatically
cannot be replayed, and specifically capturing the unique context of consent
recordable, in particular for the purposes of non-repudiation.

### PRESENTATION OF THE INVENTION

The present invention therefore relates, according to a first aspect, to a method for identifying or authenticating a user of a virtual or mixed reality system comprising means for displaying an immersive space and means for detecting movement in said immersive space of a virtual plotting device, the method being characterized in that it comprises the implementation by data processing means of a first server connected to said system of steps of:
(a) Obtaining from said system data representative of a candidate three-dimensional graphic object drawn by said user in said immersive space with said virtual plotting device;
(b) Biometrically classifying said data representative of a candidate three-dimensional graphic object drawn by said user in said immersive space with said virtual plotting device, by means of a classification model trained on a learning base of data representative of reference three-dimensional graphic objects.

According to advantageous and non-limiting characteristics:

Said method is a method for authenticating the user, said biometric classification of step (b) being a binary classification and said data of the learning base being representative of the same expected three-dimensional graphic object drawn several times by said user in said immersive space with said virtual plotting device.

Step (a) comprises a sub-step (a2) of emitting to said system an invitation to draw said candidate three-dimensional graphic object in said immersive space.

Said invitation comprises a first contextual parameter that said candidate graphic object must have, step (b) further comprising verifying that said candidate three-dimensional graphic object drawn by said user does indeed have said first contextual parameter.

The method comprises a step (c) of implementing or not a transaction initiated by said user in said immersive space depending on the result of step (b).

Step (a) comprises a sub-step (a1) of receiving a request to validate said transaction, in response to which said invitation to draw said candidate three-dimensional graphic object in said immersive space is emitted.

Step (b) further comprises verifying that said candidate three-dimensional graphic object drawn by said user has a second contextual parameter linked to said transaction.

The three-dimensional graphic object consists of a set of elementary lines, each corresponding to a continuous displacement of said virtual plotting device in said immersive space.

Each elementary line is a ribbon of polygons, said data representative of the candidate three-dimensional graphic object drawn by said user being one or several vectors of values defining, for each line of said set of elementary lines, the polygons of the ribbon, forming said line.

Each ribbon has an inclination depending on the orientation presented by said virtual plotting device in said immersive space during said continuous displacement. Said classification model is a neural network.

The method comprises a prior step (a0) of learning, by data processing means of a second server, said classification model from said learning base of reference vectors of data representative of reference three-dimensional graphic objects.

According to a second aspect, the invention relates to a server for identifying or authenticating a user of a virtual or mixed reality system connected to said server, the server being characterized in that it comprises data processing means configured to:
Obtain from said system data representative of a candidate three-dimensional graphic object drawn by said user in an immersive space with a virtual plotting device, the system comprising means for displaying said immersive space and means for detecting the movement in said immersive space of said virtual plotting device;
Implement a biometric classification of said data representative of a candidate three-dimensional graphic object drawn by said user in said immersive space with said virtual plotting device, by means of a classification model trained on a learning base of data representative of reference three-dimensional graphic objects.

According to a third aspect, the invention relates to a system comprising a server according to the second aspect and at least one virtual or mixed reality system comprising means for displaying said immersive space and means for detecting the movement in said immersive space of said virtual plotting device.

According to fourth and fifth aspects, the invention relates to a computer program product comprising code instructions for executing a method according to the first aspect for identifying or authenticating a user of a virtual or mixed reality system; and a storage means readable by computer equipment on which a computer program product is recorded comprising code instructions for executing a method according to the first aspect for identifying or authenticating a user of a virtual or mixed reality system.

### PRESENTATION OF THE FIGURES

Other characteristics and advantages of the present invention will become apparent upon reading the following description of a preferred embodiment. This description will be given with reference to the appended drawings in which:

FIG. 1 is a diagram of a system for implementing the method according to the invention;

FIG. 2 represents an example of rendering of a 3D signature used in an embodiment of the method according to the invention;

FIG. 3a represents a detail of a three-dimensional graphic object whose lines are represented by polygon ribbons.

FIG. 3b represents a detail of a three-dimensional graphic object whose lines are represented by tubular-type volumes.

FIG. 3c represents a detail of a three-dimensional graphic object whose lines are represented by voxel-type volumes.

FIG. 3d represents a detail of a three-dimensional graphic object whose lines are represented by point cloud-type volumes.

FIG. 4 is a flowchart illustrating the steps of an embodiment of the method according to the invention.

FIG. 5 schematically represents an example of fragment of ribbon of polygons forming an elementary line.

### DETAILED DESCRIPTION

### Architecture

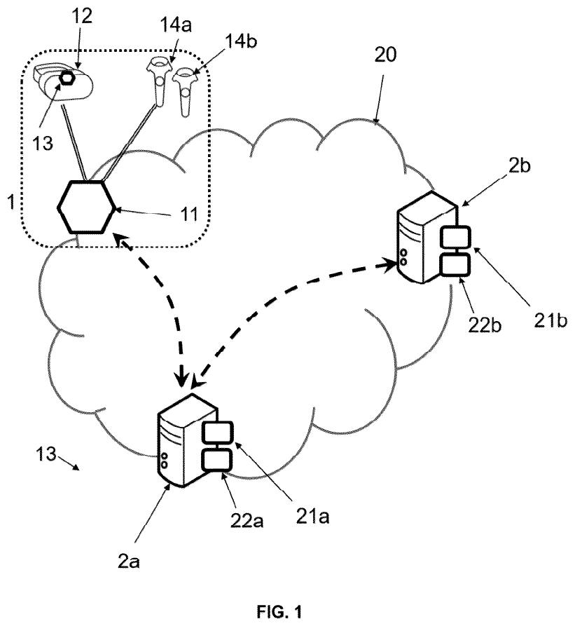

The present invention relates to a method for identifying or authenticating a user of a virtual or mixed reality system 1 as represented in FIG. 1, in particular for implementing a transaction in an immersive space to which the system 1 provides access.

Said system 1 comprises means 12 for displaying said immersive space (that is to say with which the user can interact, and in which he is “immersed”), typically a headset, and means for detecting the movement in said immersive space of a virtual plotting device 14a, 14b, generally controllers (or joysticks) held by the hands and provided with accelerometers and/or gyrometers, or alternatively fixed external cameras observing the hands. The term “virtual plotting device” means an interactive element “handled” by the user in said immersive space (thus displayed by the display means 12 within the immersive space), and by means of which he can draw by simulating an inking device. The virtual plotting device has a position and an orientation entirely determined by those of the hand and fingers, the user can therefore freely move it, orient it and operate it in the immersive space with his hands, so that said means for detecting the movement in said immersive space of said virtual plotting device can be any means for detecting the (physical) movement of the user's hands and fingers.

In the case of physical controllers 14a, 14b, the virtual plotting device may be the representation of one of the two controllers (arbitrarily the controller 14a) in said immersive space: this controller acts as a pointing device, and also exposes different mechanical buttons, each assignable to a specific interactivity function, depending on the application context. Note that the virtual plotting device may take on many appearances (and not only exactly that of the controller 14a), for example that of a “realistic” object such as a spray can or a gun. Note that certain drawing applications in the immersive space also offer the user the option of customizing the virtual plotting device (for example, configuration of the buttons) so as to optimally adapt to their needs.

It will be understood that we are not content with “drawing with the hands”, which is too simplistic for the present invention, which involves a virtual plotting device so as to allow, as we will see, the interruption/resumption of the plotting, the orientation of the line, the possibility of applying patterns, etc. (typically functionalities controlled with certain fingers such as pressing buttons). Furthermore, even in the absence of a physical controller (means 14a, 14b consisting for example of a camera observing the user's hands), we can always have a virtual plotting device held by the user in the immersive space (with, where appropriate, virtual pressing of buttons with finger movements).

The various equipment of the system 1 (for example, headset and controllers) are interconnected in a wired or wirelessly (for example via Bluetooth) manner.

Said “reality” is either:
virtual, that is to say that said immersive space is completely artificial, or
mixed, that is to say only partially virtual, and said immersive space superimposes a real environment and a virtual environment.

A mixed reality system 1 generally comprises, in addition to the display means 12, a camera filming the real world continuously, the rendering of the display means 12 including virtual elements in this “real” stream. In the remainder of the present description, the example of virtual reality, abbreviated “VR”, will be taken for convenience, but those skilled in the art will be able to transpose the environment to mixed reality (MR).

In a known manner, in all cases, the display means 12 are coupled with the movements of the user's eyes so that the display of the immersive environment evolves according to these movements so as to simulate reality. To do this, the system 2 generally comprises means for detecting the movement of the user's head 13, for example again accelerometers or cameras either external observing the head, or attached to the headset and observing the environment.

The system 1 further comprises data processing means 11 such as a processor, implementing applications in said immersive space. For example, in a shooting game, the interactivity controller simulates a weapon and pressing a button corresponds to triggering the weapon.

The system 1 preferably implements a drawing application in the immersive space, such as many already exist (examples include OpenBrush, an open source fork of Google's Tilt Brush application).

These applications allow the user to draw, paint, or model 3D content (i.e., three-dimensional graphic objects) directly in the immersive VR space. The typical configuration of these applications is:
a controller 14b (for example the left one) presents to the user a selection of tools, palette, colors, etc.
a controller 14a (for example the right one) acts as a virtual plotting device (pencil, pen, brush, etc.), which, upon pressing a button, ejects virtual “ink” remaining suspended in the immersive space.

The present method is implemented by a first server 2a which can be confused with the system 1, or remote and connected by a network 20 such as the internet network. Advantageously, there is a second server 2b (which is learning equipment as we will see), typically remote (i.e. in the network 20), but which can be confused with the first server 2a.

Each server 2a, 2b also has data processing means 21a, 21b (typically a processor) and data storage means 22a, 22b (a memory, for example a hard disk). As will be seen, the data processing means 22b of the second server 2b can store a learning database. For the sake of simplification, the learning database is called “learning base” in the remainder of the present description.

### Principle

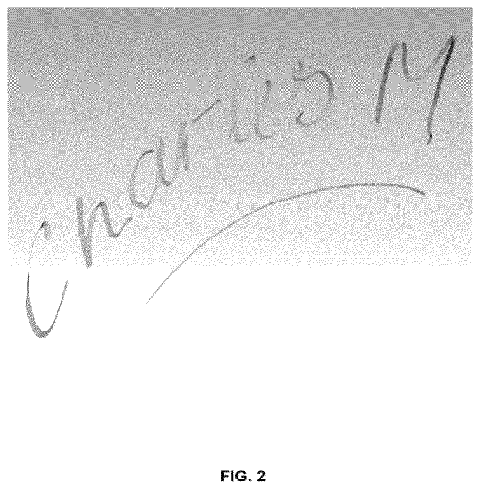

The present method aims at the biometric classification of a user of the terminal 1 (and in particular his identification or his authentication) thanks to the drawing of a three-dimensional graphic object by said user in said immersive space with a virtual plotting device, alternatively for example to known techniques such as gesture recognition or code entry. Said three-dimensional graphic object is typically a signature of the user, plotted at arm's length, see FIG. 2, even if this could be any drawing or symbol as long as it is personal and difficult to reproduce.

The present solution can be seen as biometric, insofar as biometrics brings together all the computer techniques allowing an individual to be automatically recognized based on their physical, biological and also behavioral characteristics, which includes the plotting of a signature.

And it should be noted that a VR signature is much more difficult to imitate (by another person) than a paper signature due to the following peculiarities:
General 3D curvature: due to the amplitude of the plot and a relatively fixed arm size plot, the resulting signature distribution is not a plane, but a slightly curved 3D space
3D depth of the details: parts of the same line are often on a new plane with slightly different depths, even if the user intended for the line to remain in the same plane, for example when plotting a loop
Velocity of the “brush”: the amplitude of the gesture in space means that the variation in velocity of the plot (accelerations and slowdowns) is rather marked
Orientation and inclination of the “brush”: if we define a “thickness” of the brush the resulting line is not a wire but a “ribbon” which each portion is perpendicular to the position and orientation of the controller
Initiation and Endings: the way the user initiates and ends their line (by pressing and then releasing the button of the controller) produces small hooks that may be characteristic of the user
Plotting order: the chronological order of the plotted lines, and the direction of each plot is a strong singularity not always easy to identify in a 2D signature, and easy to recover in a VR signature

As explained, said biometric classification is advantageously selected from an identification (1:N verification) or an authentication (1:1 verification) of the user, very preferably an authentication, in particular to obtain the consent of the user in said immersive space (i.e. verification). The method can be implemented at any time where the identity of the person using the system 1 may need to be determined/verified. The case at hand is a transaction validation (if the user purchases an object, real or virtual, in the immersive space).

### Method

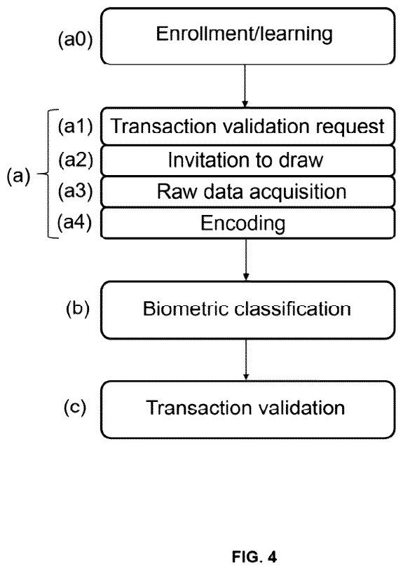

With reference to FIG. 4, the present method is implemented by the data processing means 21 of the first server 2a, and begins with a step (a) of obtaining from said system 1 data representative of a candidate three-dimensional graphic object drawn by said user with the virtual plotting device in said immersive space.

We speak of a “candidate” graphic object as being the one drawn directly by the user and on the basis of which we will attempt identification/authentication, as opposed to “reference” graphic objects, in practice those of the learning base.

In this respect, step (a) preferably comprises a sub-step denoted (a4) of encoding said candidate three-dimensional graphic object, that is to say the generation of said data representative of this three-dimensional graphic object from raw data acquired and provided by the system 1, i.e. the 3D scene (in particular from the user's point of view, i.e. in the reference system of the display means 12). Indeed, said representative data must constitute a relevant digital representation that can be understood by an AI model. Note that this encoding can be carried out directly by the system 1 or by the server 2a. Step (a) preferably comprises the acquisition (a3), by the system 1, of said raw data, while the user draws said candidate three-dimensional graphic object.

According to a preferred embodiment, said three-dimensional graphic object consists of a set of elementary lines, or “plots”, i.e. continuous lines, each corresponding to a “brushstroke”. Each elementary line corresponds to a continuous displacement of the virtual plotting device in said immersive space, and thus has a start (corresponding to the point in space where the user “placed” the brush) and an end (corresponding to the point in space where the user “raised” the brush). Typically, the user begins a line by pressing a button of the virtual plotting device (in particular a physical button of a controller 14a forming a movement detection device), and ends it by releasing this button. The movement of the controller is acquired between the two, and the line is rendered and displayed in the immersive space. The user can move his controller between two successive lines, or even change controllers if the configuration of the controllers allows it (but each line is drawn with a single controller).

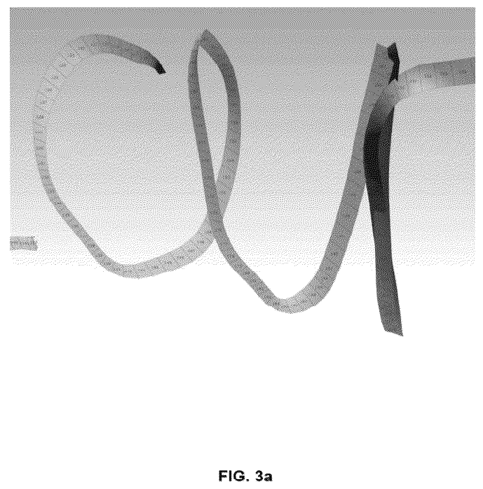

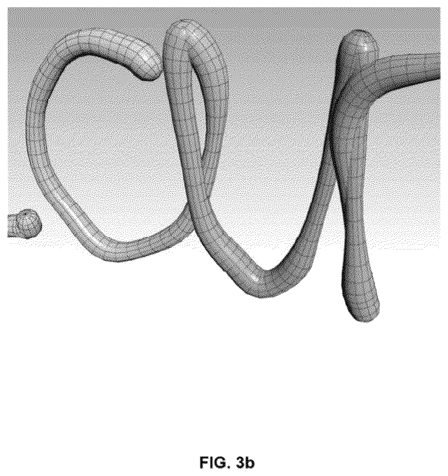

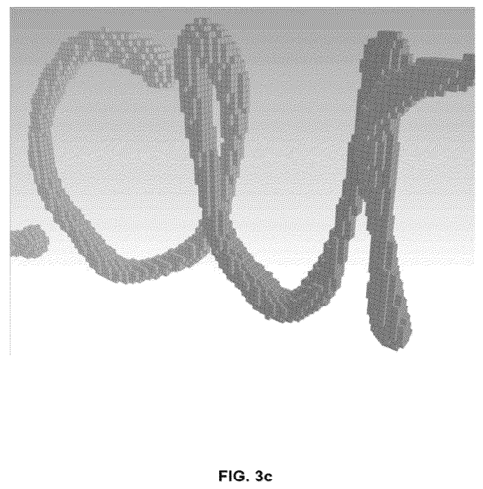

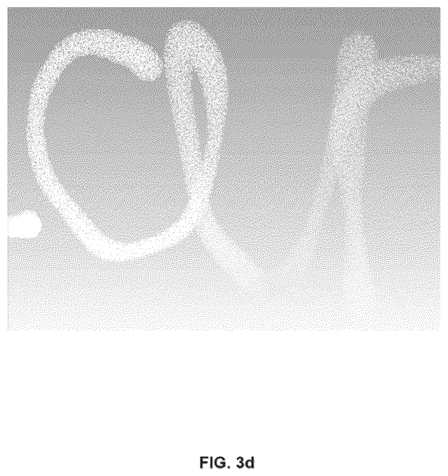

Each line can be seen as a 1D curve (thickness “zero”), or advantageously as a “ribbon” i.e. a 2D structure, preferably a ribbon of successive polygons, in particular quadrilaterals of constant width, as seen in FIG. 3a. The graphic object consists therefore of a set of ribbons of polygons, each ribbon forming an elementary line of the three-dimensional graphic object. Said raw data of the three-dimensional graphic object then correspond to a “mesh” which can be rendered in the immersive space (in particular via a ‘wireframe’ shader) and displayed by the display means 12.

Indeed, it is noted that the virtual plotting device has, in addition to a position in space, an orientation, and the idea is to capture this orientation via the inclination of the ribbon to further improve the identifying character of a 3D signature. In other words, each ribbon has an inclination depending on the orientation presented by said plotting device handled by the user in said immersive space during said continuous displacement (advantageously an inclination orthogonal to said orientation presented by said plotting device in said immersive space during said continuous displacement)

In mathematical terms, we can be recorded at regular intervals the position (x(t), y(t), z(t)) of the plotting device in an orthonormal reference frame of the immersive space and its attitude (θ(t), φ(t), ψ(t)), i.e. the orientation of a reference frame of the plotting device relative to said reference frame. Typically, in the case of controllers, these six coordinates can be directly provided by inertial measurement means, or recalculated during events.

We note, for a line, (xᵢ, yᵢ, zᵢ)=(x(t), y(t), z(t)) and (θᵢ, φᵢ, ψᵢ)=(θ(t), φ(t), ψ(t)) for t=tᵢ an acquisition instant with dt=tᵢ₊₁−tᵢ the constant time step between two successive acquisitions. In a known manner, we can calculate at each instant tᵢ from (θᵢ, φᵢ, ψᵢ) a vector (uᵢ, vᵢ, wᵢ) of predetermined norm L advantageously orthogonal to the “inking” direction (it is just a matter of knowing the fixed inking direction in the reference frame of the plotting device, for example that of the index, and of applying a rotation matrix).

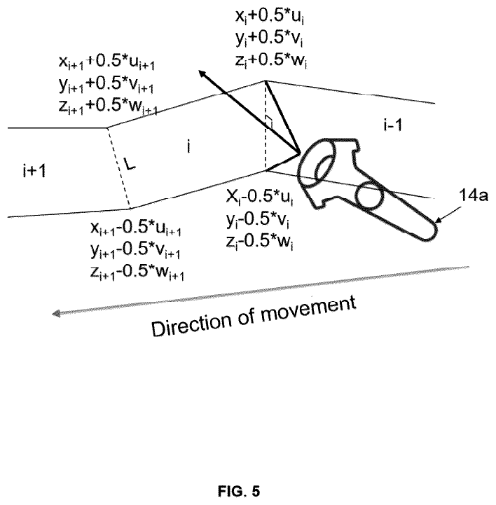

We can then define the i-th polygon of the ribbon as having as vertices the points with the following coordinates, see FIG. 5, which also represents a controller 14a and the inking direction:

$$( {x}_{i} + 0.5 * {u}_{i} , {y}_{i} + 0.5 * {v}_{i} , {z}_{i} + 0.5 * {w}_{i} ) .$$

$$( {x}_{i + 1} + 0.5 * {u}_{i + 1} , {y}_{i + 1} + 0.5 * {v}_{i + 1} , {z}_{i + 1} + 0.5 * {w}_{i + 1} )$$

$$( {x}_{i + 1} - 0.5 * {u}_{i + 1} , {y}_{i + 1} - 0.5 * {v}_{i + 1} , {z}_{i + 1} - 0.5 * {w}_{i + 1} )$$

$$( {x}_{i} - 0.5 * {u}_{i} , {y}_{i} - 0.5 * {v}_{i} , {z}_{i} - 0.5 * {w}_{i} ) .$$

We can clearly see that:
two consecutive polygons i and i+1 have a common side,
the length of a polygon (distance between (xᵢ, yᵢ, zᵢ) and (xᵢ₊₁, yᵢ₊₁, zᵢ₊₁)) represents the “velocity” of the plotting part of the plotting device, since the the acquisitions are at constant time steps
the ribbon is of constant width since we verify ∥(xᵢ+0.5*uᵢ, yᵢ+0.5*vᵢ, zᵢ+0.5*wᵢ)−(xᵢ−0.5*uᵢ₊₁, yᵢ−0.5*vᵢ₊₁, zᵢ−0.5*wᵢ₊₁)∥=∥(uᵢ, vᵢ, wᵢ)∥=∥(xᵢ₊₁+0.5*uᵢ₊₁, yᵢ₊₁+0.5*vᵢ₊₁, zᵢ₊₁+0.5*wᵢ₊₁)−(xᵢ₊₁−0.5*uᵢ₊₁, yᵢ₊₁−0.5*vᵢ₊₁, zᵢ₊₁−0.5*wᵢ₊₁)∥=∥(iᵢ₊₁, vᵢ₊₁, wᵢ₊₁)∥=L.

However, we will not be limited to this particular mathematical modeling, and any solution allowing each line to be represented by a ribbon of polygons substantially expressing the position and the orientation of the plotting device during the plotting can be used.

According to yet another embodiment, represented by FIGS. 3b, 3c and 3d, the lines can alternatively be defined as a 3D structure, for example cylindrical (case of FIG. 3b). Each “polygon ribbon” is replaced by a “volumic line” (resembling what comes out of a tube of paint), of section for example circular or prismatic.

The diameter of the section can be fixed (like the width in the case of ribbons), but alternatively the diameter of the section is variable, depending on the velocity (calculated for example as before as the distance between two successive positions (xᵢ, yᵢ, zᵢ) and (xᵢ₊₁, yᵢ₊₁, zᵢ₊₁)), which means that thin line=fast velocity, and thick line=slow velocity.

In the case of FIG. 3c, the lines are represented as sets of voxels, and in FIG. 3d, as point clouds.

Note that this embodiment no longer expresses the orientation of the plotting device, but it makes the plotting speed immediately visible and proves to be very effective for classification, see further.

In any case, the geometry of the graphic object can then (still in step (a)—between acquisition (a3) and encoding (a4)) be normalized, for example:
scaling (proportional), such that the largest dimension of its Bounding Box (Width or Height or Depth) is reduced to 1 unit (for example 1 meter).
possible rotation.

Starting from the raw data (the mesh, that is to say the spatial coordinates of all the polygons of all the lines), we can then encode them as explained in sub-step (a4).

According to a first basic mode, the complete volume of the three-dimensional graphic object is reconstructed, and said data representative of said three-dimensional graphic object are then for example a 3D matrix, i.e. a “block” of voxels (typically in the case of a volume representation of the type of FIG. 3c) or the coordinates of a point cloud (typically in the case of a volume representation of the type of FIG. 3d).

According to a second embodiment, said three-dimensional graphic object is imported into a 3D scene, and said data representative of said three-dimensional graphic object are a plurality of 2D matrices corresponding to a plurality of frames (i.e. images) produced by renderings of the three-dimensional graphic object from several viewing angles, or else several “sections” in the thickness of the three-dimensional graphic object (for example along the optical axis of the display means 12). The encoding can be carried out by performing several renderings from predefined positions.

In the first or second mode, the order of drawing of the lines can be represented by a color: in reference to the notion of hue specific to HSV or HSL color spaces, each ribbon polygon/section of a volumetric line could take a color linearly depending on its order of plotting:
First polygon/section plotted: Hue=0°
Last polygon/section plotted: Hue=359°.

As we will see, the first and second modes have the advantage of being able to use existing 2D/3D vision classification models as they are.

According to a third, preferred mode, the three-dimensional graphic object is directly represented by one or several vectors defining the volumetric ribbons/lines, i.e. said data descriptive of the candidate three-dimensional graphic object are at least one vector defining the polygon ribbons/sections forming the lines. This third mode is much lighter, since the most discriminating information is directly extracted, instead of implementing the algorithm on a complete 2D/3D image (which will contain a lot of useless information).

According to a preferred mode for the ribbons:
For each line, we can note:
   The plotting number (chronological, among other lines)
For each polygon of a line we can note:
   The plotting number of the line to which it belongs
   The plotting number of the polygon
   The absolute chronological number, so that we can compare the similarity between a strongly related signature (fewer lines or even a single line) and a less related signature (=more lines) of the same author
   The XYZ position of the center point of the polygon (vector)
   Its velocity (vector, difference between the central point of the next polygon and the central point of this polygon)
   Its orientation (vector, normal to the polygon)

The person skilled in the art will be able to transpose this approach to volumetric lines by taking the same values applied to the centers of the sections, without however the value of the inclination.

Whatever their choice, for convenience we can call “candidate” representative data the data representative of the candidate three-dimensional graphic object drawn by the user.

In a following step (b), the processing means 21a of the first server 2a authenticate or identify said user based on said candidate data, by means of a classification model trained on a learning basis of reference vectors of data representative of reference three-dimensional graphic objects. The model takes as input said candidate data (matrices, vector(s)) and returns a class, which can be either an identifier of an identity of the user (among several possible identities) or directly Boolean indicating whether the user is the expected user.

Indeed, determining the identity of the person drawing can be seen as a classification of said candidate data that represents it among a plurality of possible classes, each identity being a possible class among a plurality of possible classes (N classes) corresponding to various possible identities. Alternatively, said classification model can be binary and simply return Boolean indicating whether said candidate data are correct (i.e. correspond to the user) for authentication. Here there is no determination of the identity of the user, strictly speaking, just a verification that his 3D signature (the three-dimensional graphic object) corresponds to the expected one. To reformulate further, in the case of authentication, the classification model determines whether or not said candidate three-dimensional graphic object coincides with an expected reference three-dimensional graphic object.

Thus, as explained, it is possible to have said learning base comprising a set of data representative of reference three-dimensional graphic objects, in particular said data of the learning base being representative of the same expected three-dimensional graphic object drawn several times by said user with a virtual plotting device in said immersive space (see the enrollment aspect below), said base being for example stored by a memory 22b of the second server 2a. Note that a handful of learning data (i.e. drawing of the expected three-dimensional graphic object), in the range of five, are sufficient in the case of a signature in the form of lines in ribbons of polygons to have sufficient robustness.

It is thus possible to have a preliminary step (a0) of learning (or training) said classification model on the learning base, in particular implemented by the processing means 21b of the second server 2b, the model then being loaded onto the first server 2a. It is recalled that the second server 2b can be confused with the first server 2a.

The classification model can be consistent with any known machine learning model, and in particular learned using any suitable algorithm.

Particularly preferably, said classification model is a neural network, in particular:
In the case of descriptive data defining lines in ribbons of polygons (third embodiment), the neural network can be of the forward propagation type, FNN (Feedforward Neural Network);
In the case of descriptive data in the form of a plurality of 2D images (second embodiment) the neural network can be any network suitable for artificial vision, for example the Multiview network, MVCNN (http://vis-www.cs.umass.edu/mvonn/), either duplicated as many times as there are images, or using the different images as a multi-channel input
In the case of descriptive data in the form of a 3D volume (first embodiment) the neural network can be any network adapted to 3D vision, for example the Point-Voxel, PVCNN network
In the case of descriptive data defining volumetric lines, the neural network can be of the “point cloud” type, in particular PointNet (http://stanford.edu/~rgi/pointnet/).

In the case of a neural network, learning particularly concerns the parameters of the neural network.

### Transaction & Consent

Preferably, the method is part of a context of transaction validation context, and more specifically of the user's consent to the implementation of said transaction.

It then advantageously comprises a step (c) of implementing or not a transaction initiated by said user in said immersive space depending on the result of step (b), i.e. the result of the biometric classification (in particular authentication) of said user.

In other words, if the user has drawn the expected three-dimensional graphic object (which means that he has indeed given his consent), the result of the classification is positive and the transaction is implemented. Conversely, if the result of the classification is negative, it is because either the user has not finally given his consent (the system 1 may have mistakenly believed, following a bad manipulation by the user, that the latter wishes to implement a transaction) or that a third party has attempted to usurp his identity (and therefore that the user in the first place never gave his consent), and the transaction is not implemented.

We will understand “transaction” in the broad sense, that is to say possibly payment but also signing of a contract, transfer of rights, etc.

Preferably, step (a) comprises a sub-step (a2) of emitting to said system 1 an invitation to draw said candidate three-dimensional graphic object. It is understood that this invitation is addressed to the user and is displayed (in any form) by the means 12.

This invitation can be emitted in response to a sub-step (a1) of receiving a request to validate said transaction, received from the system 1 or another server, in particular a transaction server (which can in particular be confused in turn with the first server 2a).

Typically:
The user wishes to make a transaction in the immersive space, and carries out an associated action (such as taking a virtual object)
The system 1 communicates with a remote transaction server by indicating that the user wishes to implement a transaction;
The transaction server sends to the first server 2a a transaction validation request, to ensure that the user gives his consent (sub-step (a1));
In response, the first server 2a emits to the system 1 the invitation to draw said candidate three-dimensional graphic object in said immersive space (sub-step (a2)). It is understood that in particular this invitation is interpreted by the system to be understood by the user, for example by displaying a text in the immersive space (“please validate the transaction by drawing your signature”) but also with an audio message, etc.
The user draws using a conventional drawing application, and the system 1 acquires the raw data of the drawn three-dimensional graphic object, called candidate (sub-step (a3));
The system 1 and/or the first server 2a encodes said three-dimensional graphic object (sub-step (a4)), that is to say generates said data representative of said candidate three-dimensional graphic object from the acquired raw data;
The first server 2a can then implement the biometric classification of these data representative of said candidate three-dimensional graphic object, so as to ensure that said candidate three-dimensional graphic object coincides with an expected reference three-dimensional graphic object (step (b));
The transaction is validated if the result of the biometric classification of the data representative of said candidate three-dimensional graphic object is that said candidate three-dimensional graphic object coincides with the expected reference three-dimensional graphic object (step (c)), and the server 2a can notify this to the possible transaction server so that the latter implements the transaction.

According to a particularly preferred embodiment, said invitation comprises a first contextual parameter that said candidate graphic object must have, step (b) further comprising verifying that said candidate three-dimensional graphic object drawn by said user does indeed have said first contextual parameter.

The idea is to implement a “challenge/response” mode to ensure, for example, that the three-dimensional graphic object is not pre-recorded, and to improve security, by imposing a condition on the drawing via said contextual parameter. The invitation, as presented to the user, requires the user to manually apply this contextual parameter (for example “please validate the transaction by drawing your signature IN BLUE”), for example with the other controller 14b, which further guarantees their consent.

The contextual parameter can advantageously be generated by a function derived from the information of the context of the transaction. This context information is for example: an amount, a product, the current date, the user's identity, etc.

Among the possible methods for generating contextual parameter:
a random number can be generated, and this random number is first injected into the context of the act, and second used to generate the contextual parameter.
a hash can be generated from the information of the context, and this hash is used to generate the contextual parameter.

The contextual parameter is thus advantageously an invisible and fragile digital watermark/tattoo buried in the 3D geometry of the plot, for example by imperceptibly altering the last decimals of the 3D coordinates of the vertices of the plot. This method for representing the contextual parameter protects against the replay of a past signature, replayed as is or slightly modified, see the document A fragile watermarking scheme for 3D meshes, Hao-Tian Wu, Yiu-Ming Cheung.

Alternatively or additionally to the previous method, the contextual parameter is represented by a texture and/or a color of one or several lines of the candidate graphic object, we note that this is easily selectable in all VR drawing applications.

For example, we can:
require an alternation of colors on the lines (1st line in yellow, 2nd in blue, 3rd in red, and we start again), whose order and the different RGB colors of the lines are generated by a function derived from the information of the context of the act
Require a texture made up of a few colored threads, tangled or not, whose order (from one edge to the other) and the RGB color of each thread are generated by a function derived from the information of the context of the act.

Alternatively or additionally, step (b) further comprises verifying that said candidate three-dimensional graphic object drawn by said user has a second contextual parameter linked to said transaction. In contrast to the first contextual parameter, the possible second contextual parameter is not requested from the user in the invitation, and is inherent to said candidate three-dimensional graphic object. Moreover, it is necessarily linked to said transaction, whereas the first contextual parameter could be completely random. The objective here is the consolidation of non-repudiation.

The second contextual parameter is thus advantageously a background of the candidate graphic object, setting the context of the consent (VR store counter, seller avatar, etc.)

The result of step (b) (as used in step (c)) is dependent on said verification that said candidate three-dimensional graphic object drawn by said user does indeed have said first and/or second contextual parameter(s). In the first and second embodiments, which classify the entire 3D volume or 2D views, any contextual parameter is visible and directly verified by the implementation of the classification model. In the case where said data representative of said candidate three-dimensional graphic object are simplified (for example, representation as a polygon ribbon), it is possible to add to this data, for example, a 2D image (no need for several images as in the second embodiment) which will be verified by an algorithm dedicated to step (b) (identification of the color and/or texture of the line, and/or of a characteristic element of the background (such as a logo) and comparison with what was expected).

### Enrollment

The step (a0) of learning, i.e. obtaining the classification model, may comprise an enrollment phase to generate said data representative of a reference three-dimensional graphic object, for the learning base.

In particular, as explained, in the context of authentication, we need data representative of the same expected three-dimensional graphic object drawn multiple times by said user in said immersive space with said virtual plotting device. In the context of identification, we can simply do the same thing with multiple users.

To do this, we can draw the user (or each user) in a controlled environment, i.e. for example after having authenticated him via another existing authentication mode (biometrics, code, use of smartphone, etc.), and implement the same steps as in the authentication method.

There is thus a step (A) of obtaining from said system 1 data representative of the same expected three-dimensional graphic object drawn several times by said user in said immersive space with said virtual plotting device, which is the counterpart of step (a).

More precisely, considering that said “expected three-dimensional graphic object” is a theoretical object which is the one imagined by the user and which is in practice never exactly drawn, and defining as “reference three-dimensional graphic objects” the different occurrences of said same expected three-dimensional graphic object (which will be close but never identical), this step (A) consists of obtaining, from the system 1, for each reference three-dimensional graphic object (i.e. for each time the user attempts to draw said expected three-dimensional graphic object), data representative of this reference three-dimensional graphic object drawn by said user in said immersive space with said virtual plotting device. We can have the sub-steps (A1), (A2), (A3) and (A4) homologous to the sub-steps (a1), (a2), (a3) and (a4) of step (a):
(A1) receiving a request to enroll an expected three-dimensional graphic object from the user, for authentication.
(A2) emitting to said system 1 an invitation to draw an expected three-dimensional graphic object several times (it is understood that this involves the user choosing the expected three-dimensional graphic object).
(A3) Acquiring raw data of each three-dimensional reference graphic object drawn;
(A4) Encoding each reference three-dimensional graphic object.

In a step (B) which is the counterpart of step (b), the learning itself is carried out: adaptation of the parameters of said classification model according to the result of the biometric classification of said data representative of said same expected three-dimensional graphic object drawn by said user in said immersive space with said virtual plotting device (i.e. data representative of the various reference three-dimensional graphic objects), by means of said classification model (the model is well trained when it is capable of classifying in the same way all the data representative of the various reference three-dimensional graphic objects corresponding to the same expected three-dimensional graphic object).

### Server

According to a second aspect, the invention relates to the first server 2a for implementing the method according to the first aspect.

Thus, this first server 2a comprises, as explained, at least data processing means 21a and a memory 22a. It is typically an authentication server of an immersive space.

The data processing means 21a are configured to implement steps consisting of:
Obtaining from said system 1 data representative of a candidate three-dimensional graphic object drawn by said user in an immersive space with a virtual plotting device, the system comprising means 12 for displaying said immersive space and means for detecting the movement of said virtual plotting device in the immersive space 14a, 14b;
Implementing a biometric classification of said data representative of a candidate three-dimensional graphic object drawn by said user in said immersive space with said virtual plotting device, by means of a classification model trained on a learning base of data representative of reference three-dimensional graphic objects.

According to a third aspect, the invention proposes a system comprising said first server 2a, as well as at least one system 1 connected (via the network 20). Advantageously, said system also comprises the second server 2b, connected to the first server 2a still via the network 20.

The second server 2b comprises data processing means 21b configured to implement the learning of said classification model from said learning base of data representative of reference three-dimensional graphic objects.

### Computer Program Product

According to fourth and fifth aspects, the invention relates to a computer program product comprising code instructions for executing (on the data processing 5 means 21a of the first server 2a) a method according to the first aspect for identifying or authenticating a user of a virtual or mixed reality system 1, as well as storage means readable by computer equipment (for example the data storage means 22a of the first server 2a) on which this computer program product is found.

1. A method comprising:
identifying or authenticating a user of a virtual or mixed reality system comprising an immersive space display for displaying an immersive space and a movement detector for detecting the movement in said immersive space of a virtual plotting device, the identifying or authenticating comprising, implementing by a data processor of a first server connected to said system:
obtaining from said system data representative of a candidate three-dimensional graphic object drawn by said user in said immersive space with said virtual plotting device; and
biometrically classifying said data representative of a candidate three-dimensional graphic object drawn by said user in said immersive space with said virtual plotting device, by using a classification model trained on a learning base of data representative of reference three-dimensional graphic objects.

2. The method according to claim 1, wherein said method comprises authenticating the user, said biometric classification being a binary classification and said data of the learning base being representative of a same expected three-dimensional graphic object drawn several times by said user in said immersive space with said virtual plotting device.

3. The method according to claim 2, wherein the obtaining comprises emitting to said system an invitation to draw said candidate three-dimensional graphic object in said immersive space.

4. The method according to claim 3, wherein said invitation comprises a first contextual parameter that said candidate graphic object must have, and the classifying further comprising verifying that said candidate three-dimensional graphic object drawn by said user does indeed have said first contextual parameter.

5. The method according to claim 2, comprising implementing or not implementing a transaction initiated by said user in said immersive space depending on a result of the classifying.

6. The method according to claim 3, comprising implementing or not implementing a transaction initiated by said user in said immersive space depending on a result of the classifying, wherein the obtaining comprises receiving a request to validate said transaction, in response to which said invitation to draw said candidate three-dimensional graphic object in said immersive space is emitted.

7. The method according to claim 5, wherein the classifying further comprises verifying that said candidate three-dimensional graphic object drawn by said user has a second contextual parameter linked to said transaction.

8. The method according to claim 1, wherein said three-dimensional graphic object comprises a set of elementary lines each corresponding to a continuous displacement of said virtual plotting device in said immersive space.

9. The method according to claim 8, wherein each elementary line comprises a ribbon of polygons, said data representative of the candidate three-dimensional graphic object drawn by said user being one or several vectors of values defining, for each line of said set of elementary lines, the polygons of the ribbon, forming said line.

10. The method according to claim 9, wherein each ribbon has an inclination depending on an orientation presented by said virtual plotting device in said immersive space during said continuous displacement.

11. The method according to claim 1, wherein said classification model is a neural network.

12. The method according to claim 1, comprising, prior to the obtaining and the classifying, learning, by a data processor of a second server, said classification model from said learning base of reference vectors of data representative of reference three-dimensional graphic objects.

13. A server identifying or authenticating a user of a virtual or mixed reality system connectable to said server, the server comprising:
at least one data processor; and
at least one non-transitory computer readable medium comprising instructions stored thereon which when executed by the at least one data processor configure the server to:
obtain from said system data representative of a candidate three-dimensional graphic object drawn by said user in an immersive space with a virtual plotting device, the system comprising an immersive space display for displaying said immersive space and a movement detector for detecting the movement in said immersive space of said virtual plotting device; and
implement a biometric classification of said data representative of a candidate three-dimensional graphic object drawn by said user in said immersive space with said virtual plotting device, by using a classification model trained on a learning base of data representative of reference three-dimensional graphic objects.

14. The system comprising the server according to claim 13 and the virtual or mixed reality system comprising the immersive space display and the movement detector of the virtual plotting device.

15. (canceled)

16. A non-transitory computer readable storage medium on which a computer program product is recorded comprising code instructions for executing a method for identifying or authenticating a user of a virtual or mixed reality system, when the instructions are executed by at least one data processor of a first server, the system comprising an immersive space display for displaying an immersive space and a movement detector for detecting the movement in said immersive space of a virtual plotting device, the method comprising:
obtaining from said system data representative of a candidate three-dimensional graphic object drawn by said user in said immersive space with said virtual plotting device; and
biometrically classifying said data representative of a candidate three-dimensional graphic object drawn by said user in said immersive space with said virtual plotting device, by using a classification model trained on a learning base of data representative of reference three-dimensional graphic objects.
